(19) United States
(12) Patent Application Publication
(10) Pub. No.: US 2007/0256776 A1
(43) Pub. Date: Nov. 8, 2007

(54) REPAIR LAMINATE FOR MOUNTING BRACKETS AND METHOD OF USING THE SAME

(75) Inventor: Dennis R. Keicher, River Falls, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/381,333

(22) Filed: May 2, 2006

(51) Int. Cl. B29C 73/00; B32B 43/00

(52) U.S. Cl. 156/94

(57) ABSTRACT

Repair laminates and methods of repairing or forming various structures utilizing the repair laminates are described. The repair laminates may be useful for repairing or forming a variety of structures, and are particularly well suited for repairing mounting brackets on automobile panels. In one embodiment, a method of repairing a substrate is described, the method comprising: (a) providing a repair laminate comprising layer of pressure sensitive adhesive having two opposing surfaces, and a polymeric support backing bonded to a first surface the pressure sensitive adhesive, the support backing having a thickness of at least 0.75 millimeters; and (b) applying a second surface of the layer of pressure sensitive adhesive to the substrate to be repaired. In further embodiments, a rigid reinforcing layer is added to the construction of the repair laminate to provide further structure to substrates being made or repaired.

### TECHNICAL FIELD

The present invention is related to repair laminates and methods of making and repairing mounting brackets and other structures or substrates.

### BACKGROUND

Mounting brackets are used in a variety of applications to assist in mounting an object in place on a wall or other structure. For example, panels of automobiles may be mounted onto a car frame by the use of mounting brackets or “tabs” which hold the panel onto the frame of the car. Such mounting brackets may be damaged due to a collision, misuse, and the like. In particular, automobile bumpers are very vulnerable and are often subject to collision or other impact which may cause damage to the bumper mounting brackets. Once the mounting bracket of an automobile is broken, it must often be replaced.

Known methods of repairing mounting brackets include the use of two-part adhesive systems and plastic mesh reinforcements. These methods are difficult and time consuming to use and often fail to provide sufficient and consistent structural integrity to the bracket being repaired.

### SUMMARY

Embodiments of the present disclosure address these issues and others by describing repair laminates and methods of using the same that provide ease of use and improved structural integrity relative to prior art systems.

In an embodiment, a method of repairing a substrate is described, the method comprising:

providing a repair laminate comprising a layer of pressure sensitive adhesive having two opposing surfaces, and a plastically deformable polymeric support backing bonded to a first surface the pressure sensitive adhesive, the support backing having a thickness of at least 0.75 millimeters; and

applying a portion of the second surface of the layer of pressure sensitive adhesive to the substrate to be repaired, such that the repair laminate forms a three-dimensional structure.

In a further embodiment, a method of forming a three-dimensional structure is described, the method comprising:

providing a laminate comprising a layer of pressure sensitive adhesive having two opposing surfaces, and a plastically deformable polymeric support backing bonded to a first surface the pressure sensitive adhesive, the support backing having a thickness of at least 0.75 millimeters; and

forming the laminate into a three-dimensional structure.

### DESCRIPTION OF THE DRAWINGS

FIG. 1 shows a cross-sectional view of a repair laminate in one embodiment of the disclosure;

FIG. 2a shows a cross-sectional view of a repair laminate in a further embodiment;

FIG. 2b is a top view of the repair laminate shown in FIG. 2a;

FIG. 3 shows an automobile bumper with damaged/broken brackets;

FIG. 4 shows the automobile bumper of FIG. 3, with repaired brackets;

FIGS. 4a and 4b are exploded views showing further detail of the repaired bumper of FIG. 4; and

FIG. 5 shows a mounting bracket in a further embodiment of the disclosure.

### DETAILED DESCRIPTION

A repair laminate and method of repairing and making a substrate or other structures is described. “Substrate” as used herein refers to any structure to be repaired or a structure to be used as a support for the repair laminate. As will be described in further detail below, the repair laminate is formed of a multi-layered structure including an adhesive material and a support layer. In some embodiments, and additional rigid reinforcing material such as metal is added to the repair laminate to provide additional support. The repair laminates described herein are suitable for repairing a wide variety of three-dimensional structures. Non-limiting examples of suitable substrates include mounting tabs, such as those used to mount automobile panels, and mounting brackets used to affix items to walls or other surfaces. The laminate and methods described herein offer a clean simple means of repairing or forming mounting tabs, brackets and other structures. Due to their exceptional temperature stability, the repair laminates are suitable for use in applications such as making wire harnesses, and repairing/replacing coverings for batteries or other electronic devices.

The repair laminate described herein is similar to the automobile repair laminate described in commonly owned application Ser. No. 11/182912 (Attorney Case No. 60821US002), incorporated by reference herein in its entirety. The description herein provides a method for repairing or replacing a three dimensional structure using the repair laminate materials and an optional rigid reinforcing layer.

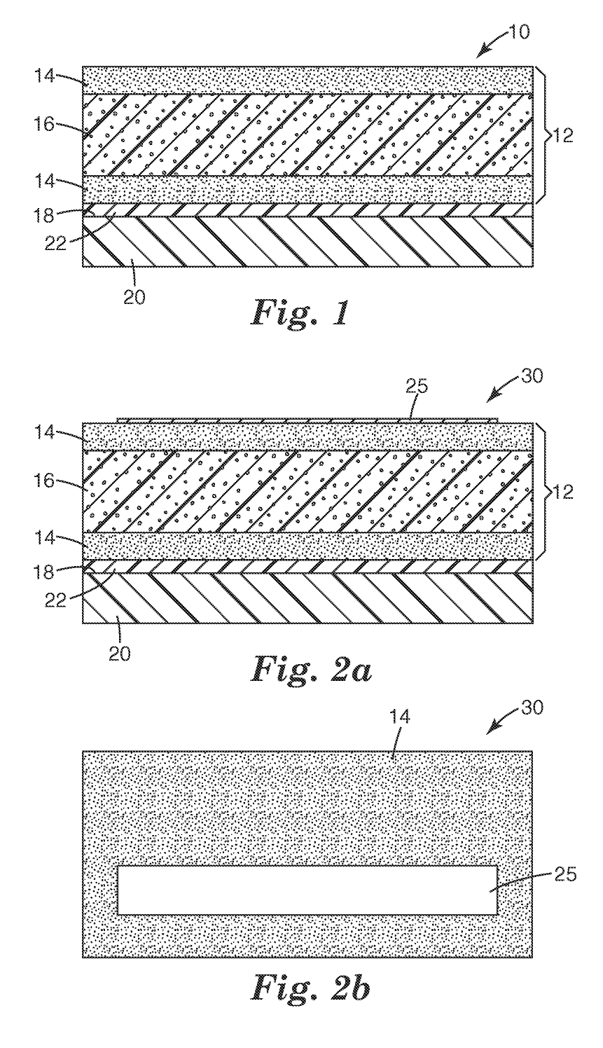

Turning now to the figures, FIG. 1 illustrates a repair laminate 10 utilized in an embodiment of the present invention. The repair laminate 10 has a composite layer 12 comprising adhesive layers 14 on opposing sides of a central core 16 of a rubber or polymeric material. In an embodiment, the core material is in the form of a polymeric foam. In other embodiments, the composite layer 12 may be completely made of an adhesive material, eliminating the need for the central core layer 16 (not illustrated). The structure of the composite layer 12 provides strength to the repair laminate while also providing a material which exhibits high energy absorption for impact resistance. Thus, structures made with or repaired by the repair laminates as described herein are less prone to breakage.

The embodiment of the repair laminate 10 shown in FIG. 1 also includes a plastically deformable support backing 20 that is bonded to the composite layer 12. In an embodiment, a surface 18 of the support backing 20 comprises an adhesion promoter layer 22 that completes the bond between the support backing 20 and the composite layer 12. The plastically deformable support backing 20 conforms in conjunction with the composite layer 12 to provide impact resistance, while also providing the structural rigidity necessary to repair a substrate. Details regarding variations of the support backing 20 and composite layer 12 in various embodiments of the repair laminate are discussed in more detail below.

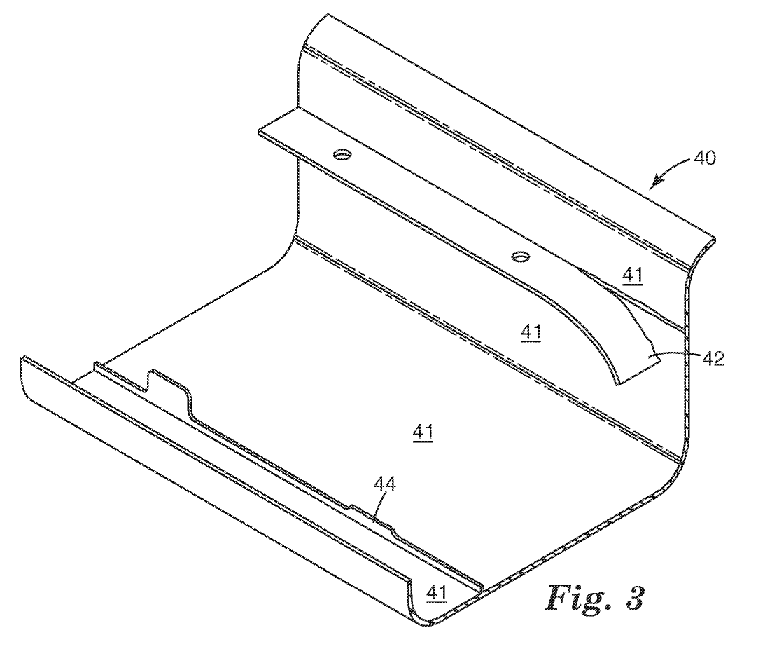

FIG. 2a illustrates a cross-sectional view of a repair laminate 30 in a further embodiment of the invention. The repair laminate shown in this embodiment has a structure similar to that of the laminate of FIG. 1, and additionally comprises a rigid reinforcing layer 25 covering at least a portion of one adhesive layer 14 of the repair laminate. FIG. 2a further shows the repair laminate as having a composite layer 12 with adhesive layers 14 surrounding a central core 16 of rubber or polymeric material. The composite layer 12 is attached to a support backing layer 20 by means of an optional adhesion promoter layer 22, applied to a surface 18 of the support backing layer 20. The structure of the repair laminate in this embodiment further comprises a rigid reinforcing layer 25 covering a portion of adhesive layer 14. As can be seen in FIG. 2b, showing a top view of the repair laminate of FIG. 2a, the rigid reinforcing layer 25 is placed on the adhesive layer 14 such that sufficient adhesive material surrounds the rigid reinforcing layer 25. In this way, the rigid reinforcing layer 25 may be aligned with the structure to be repaired and the surrounding adhesive material is used to hold the repair laminate in place. In further embodiments, the rigid reinforcing layer 25 may be aligned on an outer edge of the adhesive layer.

The support backing layer 20, while shown as a continuous layer in the drawings, may be in the form of a discontinuous layer. Should greater flexibility of the laminate material be required, portions of the support backing 20 may be removed in a continuous or random fashion to provide the desired flexibility.

As may be appreciated by one skilled in the art, the repair laminates 10, 30 described above, may be cut as appropriate to fit the structure to be made or repaired. As will be further described below, the rigid reinforcing layer 25 may be made of any rigid material, and in an embodiment, the rigid reinforcing layer 25 is made of metal.

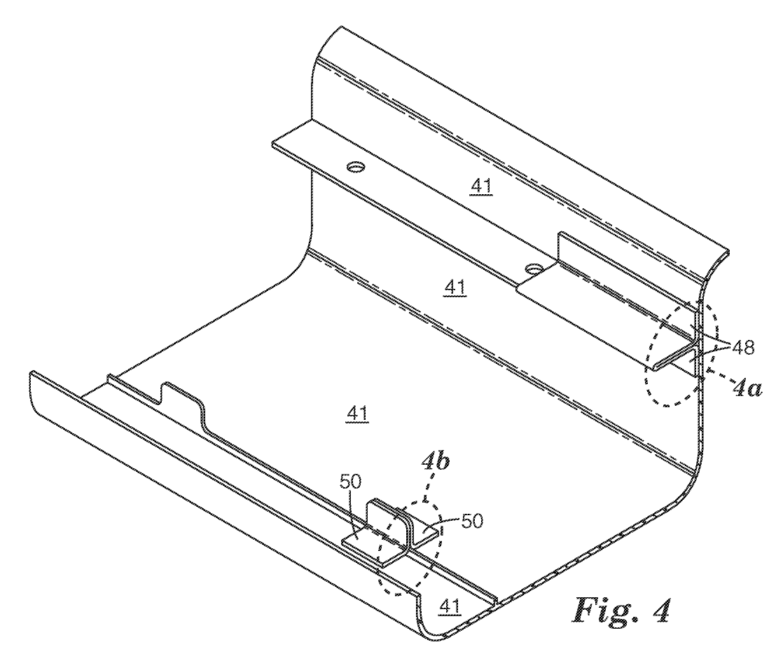

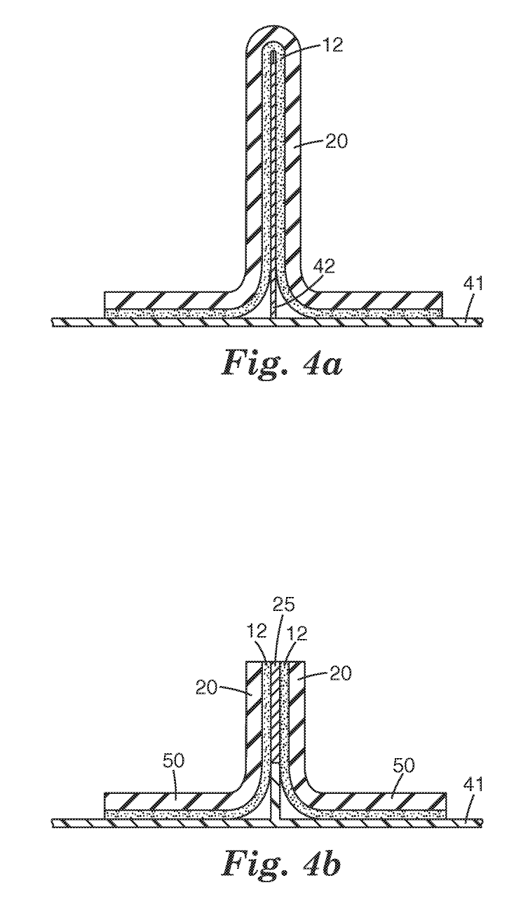

FIG. 3 depicts an automobile panel 40 having damaged or missing mounting brackets 42, 44. As used herein, an automobile panel includes any panel of an automobile including exterior panels such as doors, bumpers, fenders, and the like as well as interior panels such as the dashboard, door panels, center consoles, and the like. FIG. 4 depicts the panel of FIG. 3 repaired with the repair laminates 10, 30 described above.

To repair the damaged or missing mounting brackets 42, 44, the repair laminate 10, 30 is cut to the appropriate size and shape to match the damaged or missing bracket 42, 44, with enough additional repair laminate 10, 30 material to form an attachment flange 48, 50 against a surface 41 of the automobile panel 40. Generally, the larger the attachment flange 48, 50 the stronger the bond will be. In an embodiment, the attachment flange is approximately ½ to 1 inch in size (about 12.7 mm to about 25.4 mm).

To preserve the adhesive properties of the adhesive layer 14 and prevent unintended attachment of the repair laminate 10, 30, the adhesive layer 14 may be protected by a release liner (not shown) until the repair laminate 10, 30 is ready for use.

Prior to attaching the repair laminate 10, 30 to the automobile panel 40 to be repaired, the surfaces 41, 42, 44 of the panel may be prepared with an adhesion promoter, such as 3M Automotive Adhesion Promoter, Part No. 06396, commercially available from 3M Company, St. Paul, Minn. Repair of a damaged auto panel bracket 42 is then carried out by positioning a portion of the repair laminate 10, which will serve as an attachment flange 48, against a surface 41 of the auto panel 40, adjacent to the damaged bracket 42. The repair laminate 10 is then secured to the front surface of the damaged bracket 42 and folded over the back surface of the damaged bracket 42 with the remaining portion of the repair laminate 10 forming an attachment flange 48 on the other side of the bracket 42. FIG. 4a shows the structure of repaired bracket 42 in greater detail.

To provide additional support, repair laminate 30 may be used to repair damaged bracket 42. Repairing the automobile panel 40, using repair laminate 30 is carried out in a similar manner to the repair with laminate 10, except that a rigid reinforcing member 25, such as a piece of metal, is used to provide further structure to the broken bracket 42. The rigid reinforcing member 25, preferably cut to the same shape as the broken bracket 42, is attached to a surface 14 of the repair laminate 30 and aligned against one side of the damaged bracket 42. The remaining portions of the repair laminate 30 are attached to the opposing side of the bracket 42, and secured on both sides to the surface 41 of the automobile panel 40 forming attachment tabs 48.

Once the new tab is in place, additional laminate material may be trimmed away to replicate the size and shape of the original tab, and, if needed, holes may be drilled in the new tab to install attachment hardware.

The repair laminates described herein may also be used to repair missing mounting brackets 44 on automobile panels 40 (see FIG. 3). To repair a missing mounting bracket 44, as described in Example 1 below, an appropriately sized rigid reinforcing member 25, such as a piece of metal, is prepared and attached on opposing sides to two pieces of the repair laminate 10, which have been cut to extend beyond the rigid reinforcing member 25. The segments of repair laminate 10 extending beyond the rigid reinforcing member 25 are bent outwardly and attached to a surface 41 of the auto panel 40 to form attachment tabs 50. The repaired bracket may then be trimmed of additional repair laminate material and, if needed, a hole may be drilled in the repaired bracket for installing attachment hardware. FIG. 4 shows the repaired bracket, and FIG. 4b shows detail of the structure of the repaired bracket.

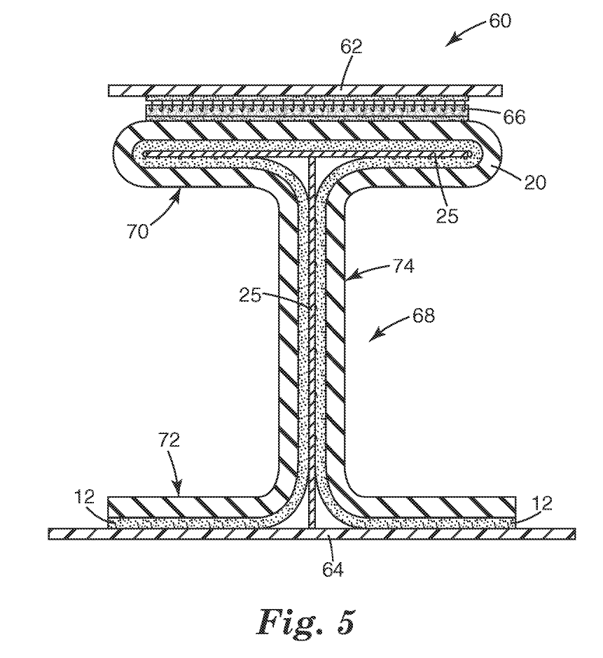

The repair laminates disclosed herein may be used to form or repair a wide variety of three-dimensional structures. FIG. 5 depicts a general mounting bracket assembly 60 made of the repair laminate materials described herein. The bracket 68 has a first anchor portion 70 and a second anchor portion 72 connected by a central arm portion 74, wherein the bracket 68 is made substantially from the repair laminates as described in FIGS. 1 and 2 above. The first and second anchor portions 70, 72 may be further configured to attach to other objects. For example, anchor portion 70, is attached, via hook-and-loop material 66 to surface 62, and anchor portion 72 is attached by means of adhesive composite layer 12 to surface 64. The bracket 68 could be used to hang an article on a wall wherein surface 62 is a wall and anchor portion 72 has an article 64 mounted to it. The bracket 68 could additionally be used in a variety of home improvement, construction or commercial applications which require brackets or other mounting structures. As may be appreciated by one skilled in the art, the repair laminate materials described herein may be used to form or repair a variety of three-dimensional structures, and the examples described herein are not intended to limit the scope of the applications.

The repair laminates described herein exhibit a wide-range of temperature stability, thus making the material appropriate for applications which would subject the laminate to extremely high or low temperatures. The materials described herein are heat stable in a range of about −20° F. (−28.8° C.) to about 200° F. (93.3° C.). Thus, the laminates described herein may be used to repair or replace coverings for batteries or other engine parts, as a harness for wires or other electronic components, or to replace or repair components in a refrigerated or frozen environment.

Repair laminates 10, 30, as described herein, may be provided in a variety formats for use in repairing automobile panels and repairing or building other structures. In one embodiment, the composite layer 12 may have a thickness of between 0.125 and 1.25 millimeters (mm), and typically around 0.40 and 0.64 mm thick. The support backing 20 in one embodiment may have a thickness between 0.75 and 5 mm, and typically between 1 and 2 mm. The repair laminates 10, 30 may be provided in a variety of shapes and sizes, as appropriate for the application. In one or more embodiments, the repair laminate 10, 30 may have a size selected such that the laminate 10 extends at least 50 mm beyond the damaged area of a structure to be repaired, such as an automobile panel. In certain embodiments, the adhesive surface 14 of a repair laminate 10, 30 may be covered by a release liner (not shown) until ready for use.

The adhesive layer 14 described herein may be made of a variety of adhesive materials known in the art. In an embodiment, the adhesive layer 14 is made of a Pressure Sensitive Adhesive (PSA). The PSA material utilized in various embodiments of the present invention may be chosen from a variety of aggressively bonding PSAs. By their nature, PSAs are inherently tacky in that they are instantaneously bonding immediately upon the application of pressure without receiving any other treatment. In an embodiment, the pressure sensitive adhesive is in the form of an acrylic foam tape. Acrylic foam tapes are commercially available under trade designations “VHB” and “Acrylic Foam Tape” from 3M Company, St. Paul, Minn. In a further embodiment, a polyurethane foam tape may be used. Polyurethane foam tapes are commercially available under the trade designations “2845 Urethane Foam Tape” “Thermalbond V2100” and “T-Bond II” from the Saint-Gobain Performance Plastics, Grandville, N.Y. The pressure sensitive adhesive material of the present invention advantageously does not need to be cured with heat or radiation in order to form a bond.

Examples of suitable pressure sensitive adhesive materials are described in U.S. Pat. No. 6,103,152 (Gehlsen et al.), U.S. Pat. No. 6,630,531 (Khandpur et al.), and U.S. Pat. No. 6,586,483 (Kolb et al.), the entire disclosures of which are incorporated by reference herein. A further example of a pressure sensitive adhesive is described in U.S. Pat. No. 6,777,080 (Khandpur et al.), the entire content of which is also incorporated by reference herein.

In an embodiment, the PSA material is an acrylic polymer foam article as described in U.S. Pat. No. 6,103,152. The foam includes a plurality of microspheres at least one of which is an expandable polymeric microsphere.

To avoid air entrapment and further improve the bonding of the adhesive layer, the surface of the adhesive layer may be formed to have a microstructured surface. The microstructured surface is formed to impart substantially continuous open pathways or grooves into the adhesive layer. The open pathways allow any air that may be trapped between the adhesive layer and the substrate to escape, thus preventing the formation of air bubbles which may reduce the adhesive bond. The microstructured surface may comprise, for example, a series of shapes including ridges, posts, pyramids, hemispheres and cones, and/or they may be protrusions or depressions having flat, pointed, truncated, or rounded parts, any of which may have angled or perpendicular sides relative to the plane of the surface. The microstructured surface may have a pattern, be random, or a combination thereof. The microstructured surface may be made as described, for example, in U.S. Pat. Nos. 6,197,397 and 6,123,890, which are incorporated herein by reference. In addition, the microstructured surface may be non-adhesive as described in U.S. Pat. No. 5,296,277; 5,362,516; and 5,141,790.

As used herein, a “polymer foam” refers to an article that includes a polymer matrix in which the density of the article is less than the density of the polymer matrix alone. In one or more embodiments, the polymeric foam material may have a substantially smooth surface, which facilitates seamless adhesion to a substrate.

A “substantially smooth” surface refers to a surface having an Ra value less than about 75 micrometers, as measured by laser triangulation profilometry. In one embodiment, the surface of the polymeric foam has an Ra value less than about 50 micrometers, in a further embodiment, the surface has an Ra value less than about 25 micrometers. The surface of the polymeric foam in certain embodiments may also be characterized by the substantial absence of visually observable macroscopic defects such as wrinkles, corrugations and creases. In addition, the surface of the polymeric foam in certain embodiments may be sufficiently smooth such that it exhibits adequate contact and, thereby, adhesion to a substrate of interest.

An “expandable polymeric microsphere” is a microsphere that includes a polymer shell and a core material in the form of a gas, liquid, or combination thereof, that expands upon heating. Expansion of the core material, in turn, causes the shell to expand, at least at the heating temperature. An expandable microsphere is one where the shell can be initially expanded or further expanded without breaking. Some microspheres may have polymer shells that only allow the core material to expand at or near the heating temperature.

The polymer foam PSA material may be constructed in one of at least two different ways. The polymer foam itself may be an adhesive, or the polymer foam material may include one or more separate adhesive compositions bonded to the foam, e.g., in the form of a continuous layer or discrete structures (e.g., stripes, rods, filament, etc.), in which case the foam itself need not be an adhesive.

The polymer foam PSA of certain embodiments may be substantially free of urethane crosslinks and urea crosslinks, thus eliminating the need for isocyanates in the composition. An example of a material suitable for making the polymer foam is an acrylic polymer or copolymer. In some cases, e.g., where high cohesive strength and/or high modulus is needed, the foam may be crosslinked.

The polymer foam of certain embodiments may include a plurality of expandable polymeric microspheres. The foam may also include one or more non-expandable microspheres, which may be polymeric or non-polymeric microspheres (e.g., glass microspheres). Examples of expandable polymeric microspheres in the polymer foam material of one or more embodiments may include those in which the shell is essentially free of vinylidene chloride units. Core materials of various embodiments may include materials other than air that expand upon heating.

The foam of various embodiments may contain agents in addition to microspheres. Examples of suitable agents include those selected from the group consisting of tackifiers, plasticizers, pigments, dyes, solid fillers, and combinations thereof. The foam may also include gas-filled voids in the polymer matrix. Such voids typically are formed by including a blowing agent in the polymer matrix material and then activating the blowing agent, e.g., by exposing the polymer matrix material to heat or radiation.

It may be desirable for the foam of certain embodiments to comprise a substantially uncrosslinked or thermoplastic polymeric matrix material. It can also be desirable for the matrix polymer of the foam of certain embodiments to exhibit some degree of crosslinking. One potential advantage to such crosslinking is that the foam will likely exhibit improved mechanical properties (e.g., increase cohesive strength) compared to the same foam with less or no crosslinking.

In an embodiment, the PSA material comprises a polymer foam that includes: (a) a plurality of microspheres, at least one of which is an expandable polymeric microsphere (as defined above), and (b) a polymer matrix that is substantially free of urethane crosslinks and urea crosslinks. The matrix includes a blend of two or more polymers in which at least one of the polymers in the blend is a pressure sensitive adhesive polymer (i.e., a polymer that is inherently pressure sensitive, as opposed to a polymer which must be combined with a tackifier in order to form a pressure sensitive composition) and at least one of the polymers is selected from the group consisting of unsaturated thermoplastic elastomers, acrylate-insoluble saturated thermoplastic elastomers, and non-pressure sensitive adhesive thermoplastic polymers.

The PSA material may be prepared in various manners, such as by: (a) melt mixing a polymer composition and a plurality of microspheres, one or more of which is an expandable polymeric microsphere (as defined above), under process conditions, including temperature, pressure and shear rate, selected to form an expandable extrudable composition; (b) extruding the composition through a die to form a polymer foam (as defined above); and (c) at least partially expanding one or more expandable polymeric microspheres before the polymer composition exits the die. It may be desirable in certain embodiments for most, if not all, of the expandable microspheres to be at least partially expanded before the polymer composition exits the die. By causing expansion of the expandable polymeric microspheres before the composition exits the die, the resulting extruded foam can be produced to within tighter tolerances.

It may be desirable in certain embodiments for the PSA material to be substantially solvent-free. In one embodiment, the PSA material may contain less than 20 wt. % solvent, in a further embodiment, the material may contain substantially none to no greater than about 10 wt. % solvent and, and in yet a further embodiment, the material may contain no greater than about 5 wt. % solvent.

The PSA material of various embodiments may possess a weight average molecular weight of at least about 10,000 g/mol in one embodiment, and at least about 50,000 g/mol, in a further embodiment. The polymers used to fabricate the PSA material of various embodiments may exhibit shear viscosities measured at a temperature of 175° C. and a shear rate of 100 sec⁻¹, of at least about 30 Pascal-seconds (Pa·s), in one embodiment, at least about 100 Pa·s in a further embodiment, and at least about 200 Pa·s in yet a further embodiment.

The PSA foam material of various embodiments may also be crosslinked. For example, the foam may be exposed to thermal, actinic, or ionizing radiation or combinations thereof subsequent to extrusion to crosslink the foam. Crosslinking may also be accomplished by using chemical crosslinking methods based on ionic interactions.

The support backing utilized in embodiments disclosed herein may be chosen from a variety of materials including plastically deformable polymeric materials including thermoplastic and thermoset materials. Being plastically deformable allows the support backing to be readily formable and to maintain its shape. In an embodiment, the plastically deformable support backing is a continuous sheet. In another embodiment, the plastically deformable support backing has an elongation at break of at least 50% according to ASTM D-412. In another embodiment, the plastically deformable support backing has an elongation at break of at least 100% according to ASTM D-412. In yet another embodiment, the plastically deformable support backing has an elongation at break of at least 200% according to ASTM D-412.

In particular, materials useful in automobile construction as body side molding and automotive cladding material may be used as the support backing. Examples include polypropylene, ethylene-propylene-diene rubbers (EPDM), thermoplastic urethanes (TPUs), reaction injection molded (RIM) urethane plastics and thermoplastic olefins (TPOs) which are copolymers of polypropylene, polyethylene, and rubber. In another embodiment, black automotive cladding, commercially available under the trade designation “Black TPO-TG Compound” from PolyOne Corporation, Cleveland, Ohio, may be used. The support backing may, optionally, comprise one or more top coats intended for other purposes, such as aesthetics, which have been shown to promote adhesion.

The rigid reinforcing layer utilized in certain embodiments disclosed herein may be made of any rigid material such as metal, rigid polymers, wood, glass and the like. In an embodiment, a 16-22 Gage sheet of metal is used.

The adhesion promoters utilized in the present invention may be chosen from a variety of materials according to the type of damaged body panel and the repair laminate employed. Exemplary adhesion promoters include those for acrylic foam tapes, RIM and TPO, commercially available under the trade designations 3M Automix Polyolefin Adhesion Promoter, Part No. 5907 and 3M Automotive Adhesion Promoter Part number 06396 from 3M Company, St. Paul, Minn.

When using a solvent based adhesion promoter, such as the 5907 or 06396 adhesion promoters, the repair laminate is produced by applying the solvent to a side of the support backing, such as the smooth side of TPO. The side of the support backing with the solvent applied is then placed into contact with the PSA and pressure may be applied. The solvent is allowed to dry and the TPO is bonded to the PSA as a result.

When using an adhesion promoter other than one which is solvent based, then the adhesion promoter may be applied to the support backing such as the smooth side of TPO and pressure may be applied. The adhesion promoter may be applied as a polymerizable liquid and is cured by electron beam radiation, as described in U.S. Pat. No. 6,287,685 (Janssen, et al.) and European Pat. No. 384,598 (Johnson, et al.), the disclosures of which are incorporated by reference herein. This radiation causes the two monomers of the adhesion promoter to polymerize, which grafts the adhesion promoter to the support backing.

To further illustrate the use of embodiments of the present invention, non-limiting examples of specific embodiments of the present invention provided solely for purposes of illustration are discussed below in conjunction with comparatives. Unless otherwise noted in the discussion of the examples and comparatives, all parts, percentages, and ratios reported are on a weight basis, and all reagents used in the examples and comparatives were obtained, or are available, from general chemical suppliers such as the Sigma-Aldrich Chemical Company, Saint Louis, Mo., or may be synthesized by conventional techniques.

### EXAMPLE 1

The following materials used in the examples are commercially available from 3M Company, St. Paul, Minn., under the trade designations:

“3M General Purpose Adhesive Cleaner, Part No. 08984”;

“3M Automotive Adhesion Promoter, Part No. 06396”;

“3M EZ Fix Flexible Patch, Part No. 05888”.

A 1 inch by 2 inches by 13 mils. (2.5 by 5.1 centimeters (cm) by 0.33 millimeters (mm)) sheet of galvanized mild steel was wiped with the general purpose cleaner. The adhesion promoter was applied to both faces of the sheet metal and allowed to dry for 5 minutes at 20° C. Likewise, an interior section of a 2004 Chevrolet Malibu rear bumper was prepared for the repair tab by cleaning and applying the adhesion promoter.

A 1 inch by 2 inches (2.5 by 5.1 cm) section of liner on a 1 inch by 3 inches (2.5 by 7.6 cm) piece of flexible repair patch was scored and removed to expose the adhesive face of the patch. The repair patch was then applied flush to one face of the sheet metal. A second piece of repair patch was applied to the opposite face of the sheet metal in a similar fashion.

The two tabs of repair patch extending beyond the face of the sheet metal were manually bent outwardly to an angle of 90° to form a pair of flanges flush with the edge of the sheet metal. The remaining sections of liner were removed from the flanges to form a 3-dimensional repair tab. The repair tab was pressed onto the inside section of the rear bumper that had previously been prepared.

The repair tab was then manually pulled with sufficient force to cause gross distortion of the bumper without detaching.

### EXAMPLE 2

A 3-dimensional repair tab was prepared according to the method outlined in Example 1, wherein a 5/16-inch (7.94 mm) hole was drilled through the center of the repair tab. Again, the repair tab remained firmly bonded after pulling with sufficient force to cause distortion of the bumper.

What is claimed is:

1. A method of repairing a substrate comprising:
providing a repair laminate comprising a layer of pressure sensitive adhesive having two opposing surfaces, and a plastically deformable polymeric support backing
bonded to a first surface the pressure sensitive adhesive, the support backing having a thickness of at least 0.75 millimeters; and
applying a portion of the second surface of the layer of pressure sensitive adhesive to the substrate to be repaired, such that the repair laminate forms a three-dimensional structure.

2. The method of claim 1, further comprising the step of applying a rigid reinforcing layer to at least a portion of the second surface of the layer of pressure sensitive adhesive, before applying a portion of the second surface of the layer of pressure sensitive adhesive to the substrate to be repaired.

3. The method of claim 1, wherein the substrate is a mounting bracket for the body panel of an automobile.

4. The method of claim 2, wherein the substrate is a mounting bracket for the body panel of an automobile.

5. The method of claim 3, wherein the body panel is a bumper.

6. The method of claim 1, wherein the support backing has an elongation at break of at least 50% according to ASTM D-412.

7. The method of claim 1, wherein the support backing has an elongation at break of at least 100% according to ASTM D-412.

8. The method of claim 1, wherein the support backing has an elongation at break of at least 200% according to ASTM D-412.

9. The method of claim 1, wherein the pressure sensitive adhesive comprises a foam.

10. The method of claim 9, wherein the pressure sensitive adhesive comprises adhesive layers on opposing sides of a central core of a rubber or polymeric material.

11. The method of claim 1, wherein the pressure sensitive adhesive contains a microstructured surface.

12. The method of claim 1, wherein the support backing is a continuous thermoplastic polyolefin sheet.

13. The method of claim 1, wherein the repair laminate further comprises an adhesion promoter between the first surface of the layer of pressure sensitive adhesive material and the polymeric support backing, thereby contributing to the bonding between the support backing and the pressure sensitive adhesive.

14. The method of claim 1, further comprising the step of applying an adhesion promoter to the substrate to be repaired thereby contributing to the bonding between the second surface of the layer of pressure sensitive adhesive and the substrate to be repaired.

15. The method of claim 13 or 14, wherein the adhesion promoter is a solvent based adhesion promoter.

16. The method of claim 13 or 14, wherein the adhesion promoter is applied as a polymerizable liquid.

17. A method of forming a three-dimensional structure comprising:
providing a laminate comprising a layer of pressure sensitive adhesive having two opposing surfaces, and a plastically deformable polymeric support backing bonded to a first surface the pressure sensitive adhesive, the support backing having a thickness of at least 0.75 millimeters; and
forming the laminate into a three-dimensional structure.

18. The method of claim 17, further comprising the step of applying a rigid reinforcing layer to at least a portion of the second surface of the layer of pressure sensitive adhesive, before forming the laminate into a three-dimensional structure.

19. The method of claim 17, wherein the structure is a wire harness.

20. The method of claim 17, wherein the structure is a bracket.

21. The method of claim 17, wherein the structure is a battery cover.
